(19) United States
(12) Patent Application Publication
(10) Pub. No.: US 2015/0286490 A1
(43) Pub. Date: Oct. 8, 2015

(54) I/O REDIRECTION METHOD, I/O VIRTUALIZATION SYSTEM AND METHOD, AND CONTENT DELIVERY APPARATUS

(71) Applicant: Wistron Corp., New Taipei City (TW)

(72) Inventor: Chih-Ming CHEN, New Taipei City (TW)

(21) Appl. No.: 14/304,282

(22) Filed: Jun. 13, 2014

(30) Foreign Application Priority Data
Apr. 3, 2014 (TW) 103112620

(51) Int. Cl. G06F 9/455; G06F 21/56

(52) U.S. Cl. CPC G06F 9/455; G06F 9/4555; G06F 9/45558; G06F 21/56; G06F 2009/45579

(57) ABSTRACT

Disclosed herein is an input/output (I/O) redirection method, comprising receiving a call from a virtual machine for a first procedure, selectively executing the first procedure, and selectively calling a second procedure based on an external arrangement. The first procedure is associated with an I/O operation on the virtual machine and executed when the external arrangement indicates that the second procedure not be called. The second procedure is called when the external arrangement indicates so, and executed outside of the virtual machine. Also disclosed is an I/O virtualization system, comprising a front-end module and a back-end module. The front-end module, disposed in an operating system of the virtual machine, calls the first procedure based on the I/O operation. The back-end module, disposed in a hypervisor managing the virtual machine, is configured to implement the said method. The said system may further comprise a device configured to execute the second procedure.

### CROSS-REFERENCE TO RELATED APPLICATIONS

This non-provisional application claims priority under 35 U.S.C. §119(a) on Patent Application No. 103112620 filed in Taiwan, R.O.C. on Apr. 3, 2014, the entire contents of which are hereby incorporated by reference.

### TECHNICAL FIELD

The present invention relates to input/output (I/O) virtualization, particularly to redirecting, in para-virtualization, hypercalls associated with I/O operations.

### BACKGROUND

It is standard practice to install anti-virus software on a physical machine and let it update itself and scan that physical machine. In a virtualized environment, however, simply replacing the concept of a physical machine with a virtual one is not entirely feasible. Specifically, there may be multiple virtual machines running on a physical machine. If every virtual machine was to have a copy of anti-virus software, and every such copy was to perform updates and scans periodically, the computational burden on the underlying physical machine would be unimaginable. Although instantaneous performance bottlenecks could be alleviated on the physical machine if the updates and scans were scheduled to avoid each other, it is up to administrative prudence to prioritize the virtual machines and reduce the impact of asynchrony. Even if only agents are installed on the virtual machines, there is still the administrative concern that control over the machines is partially relinquished and security and stability compromised.

### SUMMARY

The present invention discloses an I/O redirection method and an I/O virtualization system, wherein the latter comprises an implementation of the former. The present invention also discloses a content delivery apparatus configured to deploy a computer capable of execute the said method, and another method corresponding to the said system.

In the I/O redirection method provided by this disclosure, a call from a virtual machine for a first procedure is received. The first procedure is selectively executed, and a second procedure is selectively called based on an external arrangement in order that an execution result be obtained. The first procedure is associated with an I/O operation on the virtual machine and is executed when the external arrangement indicates that the second procedure not be called. The second procedure is called when the external arrangement indicates that the second procedure be called and is executed outside of the virtual machine.

The I/O virtualization system provided by this disclosure is for handling an I/O operation on a virtual machine. The system comprises a front-end module and a back-end module. The front-end module, disposed in an operating system of the virtual machine, is configured to call the first procedure based on the I/O operation. The back-end module is disposed in a hypervisor, configured to selectively execute the first procedure, and configured to selectively call a second procedure based on an external arrangement in order to obtain an execution result. The virtual machine is managed by the hypervisor. The second procedure is executed outside of the virtual machine. The back-end module is configured to call the second procedure when the external arrangement indicates that the second procedure be called, and configured to execute the first procedure when the external arrangement indicates that the second procedure not be called.

The I/O virtualization method provided by this disclosure is for handling an I/O operation on a virtual machine. A call for a first procedure is made at the virtual machine based on the I/O operation. The first procedure is selectively executed at a hypervisor, and another call for a second procedure is selectively made at the hypervisor based on an external arrangement in order that an execution result be obtained. The virtual machine is managed by the hypervisor. The first procedure is executed when the external arrangement indicates that the second procedure not be called. The second procedure is called when the external arrangement indicates that the second procedure be called and is executed outside of the virtual machine.

The content delivery apparatus provided by this disclosure is configured to deploy the computer so that the computer is provided with program code which causes the computer to execute a plurality of instructions. The instructions comprise receiving a call from a virtual machine for a first procedure, selectively executing the first procedure, and selectively calling a second procedure based on an external arrangement in order to obtain an execution result. The first procedure is associated with an I/O operation on the virtual machine and is executed when the external arrangement indicates that the second procedure not be called. The second procedure is called when the external arrangement indicates that the second procedure be called and is executed outside of the virtual machine.

In some embodiments, the I/O operation is associated with an I/O object, and the second procedure comprises determining whether there is malicious program code in the I/O object. Thus the second procedure, whose existence and details of execution need not be known to the virtual machine, can be called at the para-virtualization layer when there is security concern over the I/O operation.

### BRIEF DESCRIPTION OF THE DRAWING

The present invention will become more fully understood from the detailed description given hereinbelow and the accompanying drawings which are given by way of illustration only and thus are not limitative of the present invention and wherein:

FIG. 1 is a block diagram of the I/O virtualization system, in accordance with an embodiment of the present invention.

FIGS. 2A and 2B are flowcharts of the I/O redirection method, in accordance with various embodiments of the present invention.

FIGS. 3A, 3B, and 3C are flowcharts of the I/O virtualization method, in accordance with various embodiments of the present invention, wherein the first procedure is respectively associated with opening a file, closing a file, and notifying the back-end module to read a buffer.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

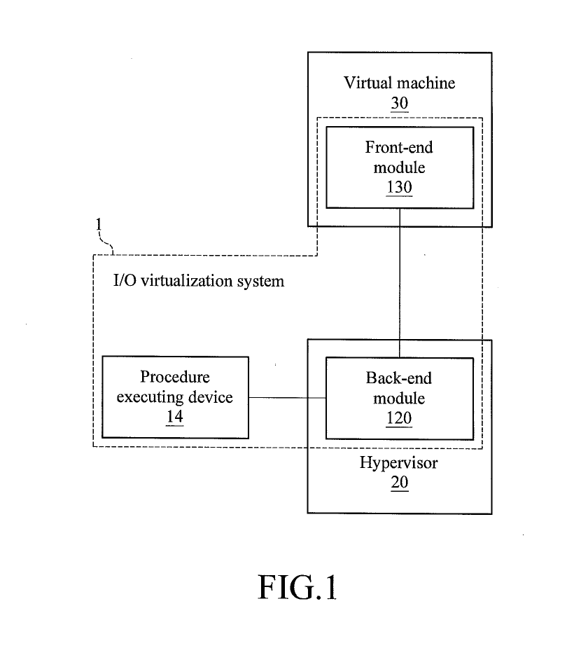

Please refer to FIG. 1. As shown in the block diagram, an input/output (I/O) virtualization system 1 comprises a front-end module 130 and a back-end module 120. The front-end module 130 is disposed in an operating system of a virtual machine 30. The back-end module 120 is disposed in a hypervisor 20 managing the virtual machine 30 and is coupled with the front-end module 130. In this embodiment, the I/O virtualization system 1 further comprises a procedure executing device 14 that is coupled with the back-end module 120.

A user would generate an I/O operation on the virtual machine 30. The I/O operation may be associated with opening, closing, or executing a file. There are usually corresponding system calls for these operations, e.g. open, close, and execve as defined in Linux operating systems. In one embodiment, the front-end module 130 is a hooked or injected kernel module or driver configured to receive these system calls, which would otherwise be handled by some built-in program code of the operating system. Specifically, the front-end module 130 augments or replaces at least in part the executable, object code, or machine code that handles these system calls in the operating system.

One way to hook the front-end module 130 is to direct entries in the system call table of the operating system (syscall_table.S in some Linux distributions) instructing how these system calls should be handled toward the file path or memory location on which the front-end module 130 resides. As a matter of fact, the front-end module 130 can handle any system call in the table, whether it is related to I/O or not. In an operating system without an apparent system call table, hooking the front-end module 130 may involve replacing the I/O area where the built-in program code resides directly with the front-end module 130, and selectively backing up the built-in program code beforehand.

The I/O operation need not comprise a system call, nor is it necessarily associated with a file. On Linux virtual machines, for instance, the user may “enter” the kernel space for an I/O operation and invoke the front-end module 130 through a socket or the process file system (procfs). In one embodiment, as the gateway of the virtual machine 30 facing the hypervisor 20, the front-end module 130 may share a generalized buffer with the back-end module 120, the two modules 120 and 130 passing data to each other in streams. Similarly, in this embodiment, the front-end module 130 may be a kernel module or a driver.

The back-end module 120 comprises an application programming interface (API) exposed by the hypervisor 20 to the virtual machine 30. It may also comprise at least part of the library further back. The front-end module 130 calls a function provided by the back-end module 120 based on the said I/O operation; that is, the first procedure is called. In one embodiment, the first procedure corresponds to the system call constituting the I/O operation. In other words, assuming that the front-end module 130 is responsible for handling the system call “open,” then there is a corresponding “open” function on the API.

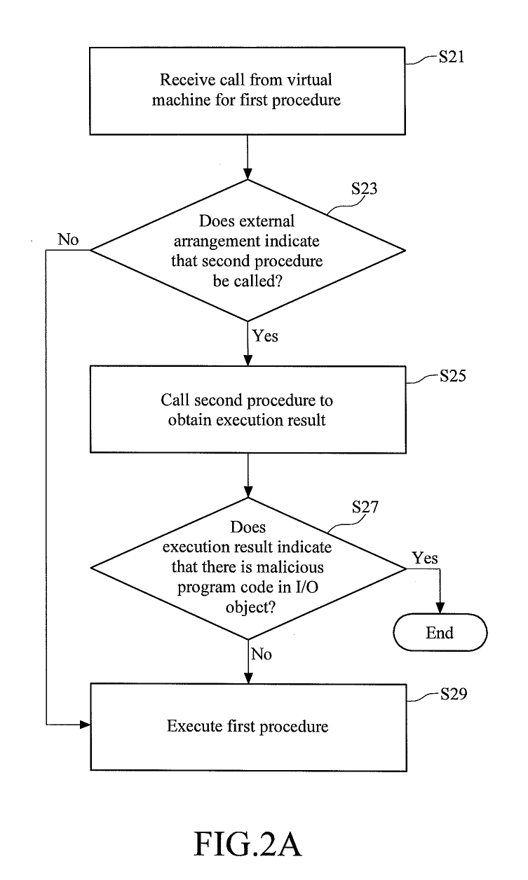

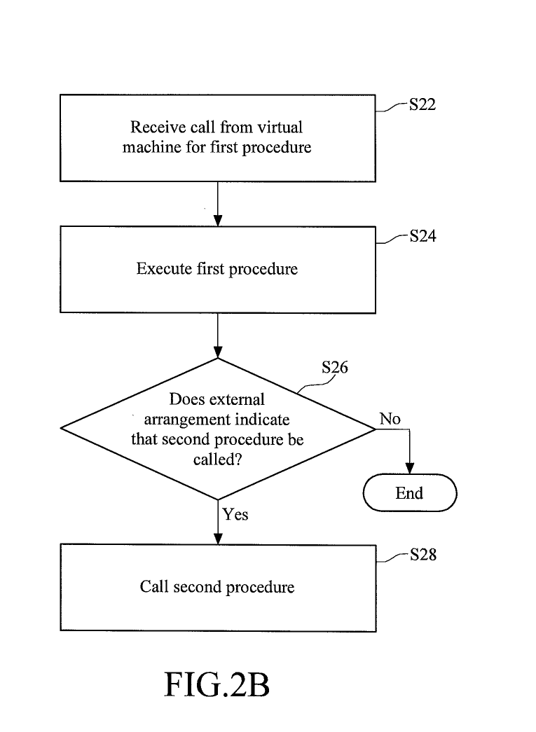

Please refer to FIG. 2A. As shown in the flowchart, after receiving in step S21 the call for the first procedure from the front-end module 130 or the virtual machine 30, based on an external arrangement (step S23), the back-end module 120 calls (step S25) or does not call a second procedure that is executed outside of the virtual machine 30. In accordance with the embodiment of FIG. 1, the second procedure is carried out by the procedure executing device 14. The said I/O operation is associated with an I/O object. Suppose that the second procedure comprises determining whether there is malicious program code in the I/O object. The procedure executing device 14 may comprise a third-party virus scanning service, whose updating and operation are thereby separated from the virtual machine 30 or even the physical machine on which it resides. The procedure executing device 14 may be a physical or a virtual machine; be it virtual, it may be on the same physical one as the virtual machine 30. In another embodiment, the second procedure is executed by the hypervisor 20. When the external arrangement indicates that the second procedure not be called, the back-end module 120 simply executes the first procedure in step S29.

Based on an execution result of the second procedure (step S27), the back-end module 120 selectively executes the first procedure as initially called by the front-end module 130. In particular and in the above example where the second procedure comprises determining whether there is malicious program code in the I/O object, the back-end module 120 executes the first procedure in step S29 if the execution result indicates that there is not malicious program code in the I/O object; otherwise the executer of the second procedure (e.g. the procedure executing device 14) takes corresponding measures, such as deleting, isolating, or ignoring the I/O object, or attempting to clear the malicious program code, whereas the first procedure is not executed by the back-end module 120.

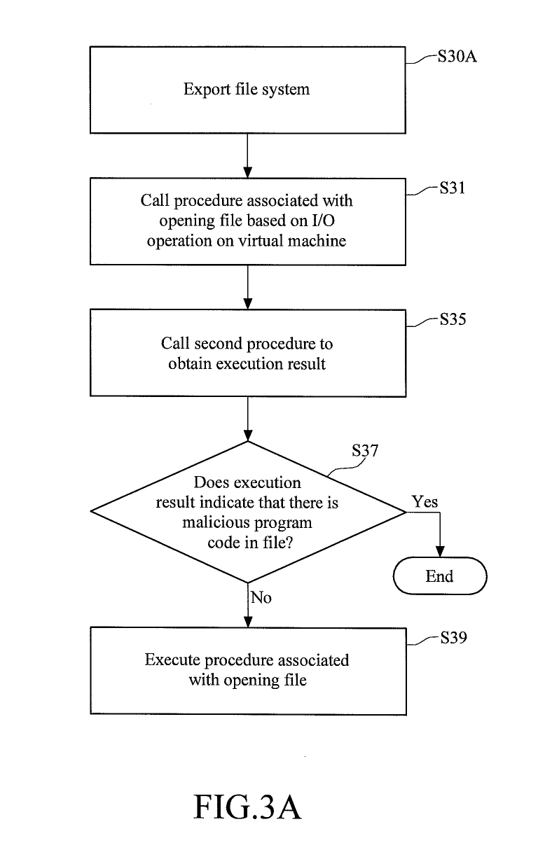

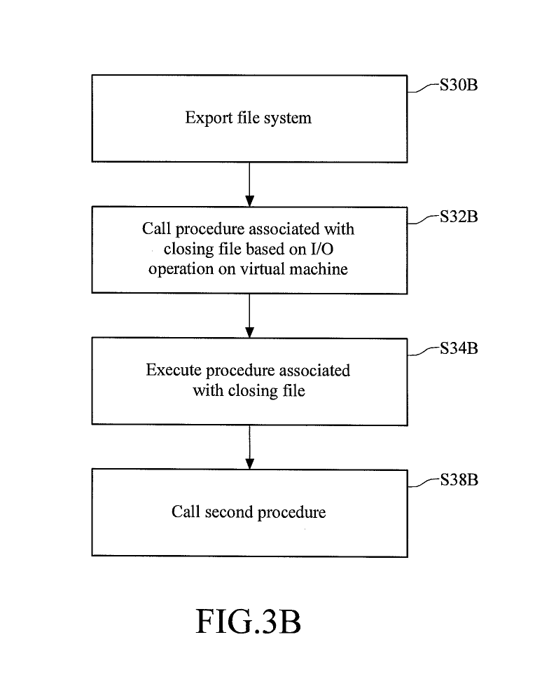

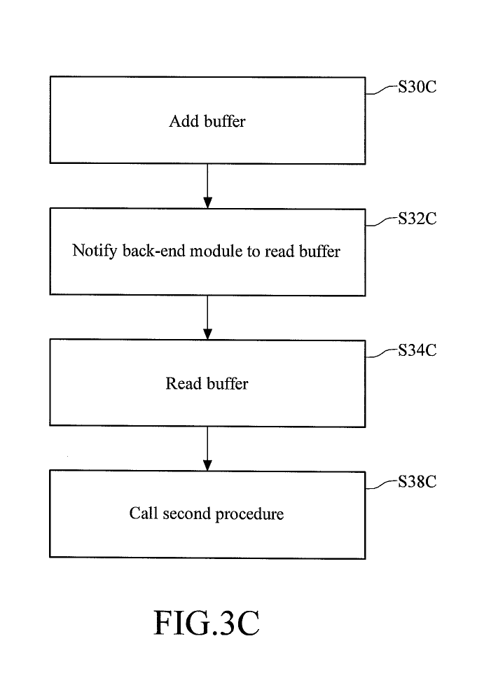

The I/O redirection method in FIG. 2A is applicable to cases where the front-end module 130 receives a system call associated with opening or executing a file. With several details laid out and assuming that the external arrangement indicates that the second procedure be called, FIG. 2A turns into FIG. 3A, where an I/O virtualization method is shown. In one embodiment, the front-end module 130, expecting the execution of the first procedure (associated with opening or executing the file; FIG. 3A illustrates the “open” case) or the second procedure, exports or exposes in step S30A a file system providing access to the file before, during, or after calling the first procedure in step S31 (corresponding to step S21). The file system need not be of the same format as an internal file system of the virtual machine 30. For instance, the virtual machine 30 may use ext4, but the front-end module 130 exports Windows-compatible NTFS or FAT32. In the embodiment where the second procedure is carried out by the procedure executing device 14, the exported file system can be accessed by the procedure executing device 14, which would mount the file system for example. In other embodiments, the hypervisor 20 brokers access to the file by the executer of the second procedure (e.g. the procedure executing device 14). The executer of step S30A, be it the hypervisor 20 or the front-end module 130, is obligated to synchronize the file system as seen by the virtual machine 30 with the exported file system, implementing, for example, two-phase commit and atomic transactions on the virtual machine 30. Steps S35, S37, and S39 are similar to steps S25, S25, and S29 of FIG. 2A, respectively.

FIG. 2B depicts another aspect of the I/O redirection method. In this embodiment, the back-end module 120 executes the first procedure in step S24 when the call for it is received in step S22 from the front-end module 130 or the virtual machine 30, and only after that does it call (step S28) or not call the second procedure executed outside of the virtual machine 30 based on the external arrangement (step S26). In accordance with the embodiment of FIG. 1, the second procedure is carried out by the procedure executing device 14. The said I/O operation is associated with an I/O object. Suppose that the second procedure comprises determining whether there is malicious program code in the I/O object. The procedure executing device 14 may comprise a third-party virus scanning service, whose updating and operation are again separated thereby from the virtual machine 30 or even the physical machine on which it resides. The procedure executing device 14 here may similarly be a physical or a virtual machine; be it virtual, it may be on the same physical one as the virtual machine 30. In another embodiment, the second procedure is executed by the hypervisor 20. The executer of the second procedure (e.g. the procedure executing device 14) takes corresponding measures if the execution result indicates that there is malicious program code in the I/O object. When the external arrangement indicates that the second procedure not be called, the back-end module 120 provides the front-end module 130 with a return value of the first procedure.

The I/O redirection method in FIG. 2B is applicable to cases where the front-end module 130 receives a system call associated with closing a file. With several details laid out and assuming that the external arrangement indicates that the second procedure be called, FIG. 2B turns into FIG. 3B, where another I/O virtualization method is shown. In one embodiment, the front-end module 130 or the back-end module 120, expecting the execution of the first procedure (associated with closing the file) or the second procedure, exports or exposes in step S30B a file system providing access to the file before, during, or after the first procedure is called in step S32B (corresponding to step S22). Please refer to the description of step S30A of FIG. 3A for details of step S30B. Steps S34B and S38B are similar to steps S24 and S28 of FIG. 2B, respectively.

Virtio exemplifies an implementation of para-virtualization with corresponding front- and back-ends residing respectively in a virtual machine and a hypervisor. Virtio supports Linux virtual machines and hypervisors like KVM and lguest. Other common hypervisors, including Xen, also contain comparable functionality, e.g. Guest Tools of VMware or Guest Additions of VirtualBox. The present invention, therefore, does not enforce the employment of Virtio. To adapt Virtio to the present invention, the “open,” “close,” and “execute” functions corresponding to system calls must be added in the API (the data structure virtqueue_ops) that the hypervisor 20 probes into the virtual machine 30, in addition to injecting the front-end module 130 for cases where the I/O object is a file. When the I/O operation is not about a file or system call, the block device driver virtio-blk or the network device driver virtio-net may be regarded as the front-end module 130 to exchange data using a native buffer of Virtio with the back-end module 120 to redirect the hypercall from the virtual machine 30 associated with the I/O operation.

The I/O redirection method in FIG. 2B is applicable to cases where buffers are employed in data transmission. Specifically, suppose that the I/O operation is associated with writing into a storage device and that the external arrangement indicates that the second procedure be called. With several details laid out, FIG. 2B turns into FIG. 3C, where yet another I/O virtualization method is shown. In step S30C, the front-end module 130 adds a buffer and fills the data to be written inside. In Virtio, the buffer is added by calling the add buf function provided by the back-end module 120. In step S32C, the front-end module 130 calls the first procedure to notify and kick (or synchronize) the buffer to the back-end module 120, who then reads the data in the buffer in step S34C. Since the buffer is only shared between the front-end module 130 and the back-end module 120, it is by no means accessible by the executer of the second procedure (e.g. the procedure executing device 14). The back-end module 120 has to execute step S34C first in order to call the second procedure (step S38C) and provide relevant data.

The hypervisor 20 often manages multiple virtual machines in reality. In one embodiment, the hypervisor 20 responds to the front-end modules of different virtual machines with the same back-end module 120. In one embodiment, the hypervisor 20 prepares a back-end module for each virtual machine that it manages. In one embodiment, the hypervisor 20 may put the virtual machines in groups, wherein virtual machines of the same group corresponds to a single back-end module, and virtual machines corresponding to one back-end module are of the same group. Technically, the virtual machine 30 need not be managed only by one hypervisor 20. The front-end module 130, therefore, might have to face and adapt API-wise to multiple back-end modules of plural hypervisors.

The external arrangement as mentioned in steps S23 and S26 can be variously implemented. For instance, the library of the back-end module 120 may be swapped by the hypervisor 20, the procedure executing device 14, or another external device to control whether the back-end module 120 calls the second procedure, or that the external arrangement is indeed a truth or Boolean value whose indication is determined by the back-end module 120 in step S23 or S26. The truth value may belong to an array or list when the back-end module 120 is in a one-to-many relationship with front-end modules. Among the virtual machines that it is responsible for, the asserter of the external arrangement (e.g. the procedure executing device 14) may choose the ones for which to carry out the second procedure (e.g. scanning for malicious program code) based on rules or experience. One procedure executing device 14 should ideally correspond with many virtual or even physical machines. When the I/O virtualization system 1 comprises a plurality of procedure executing devices, there may be load balancing between them.

In one embodiment, the procedure executing device 14 (and other ones that may exist) is subject to a security intelligence and analytics (SIA) device. Information or events regarding the updating, suspicion, scanning, etc of or by the procedure executing device 14 may reach the SIA device, which accordingly performs big-data mining. In particular, the SIA device may execute linear classification (e.g. support vector machine) or another machine learning algorithm in a real-time distributed computing architecture (e.g. Apache Storm), identify a potentially infected virtual machine (group), instruct the procedure executing device 14 to assert the external arrangement (to redirect hypercalls from the virtual machine to the second procedure), and decoct and issue a cure.

The content delivery apparatus of the present invention is configured to deploy a physical machine, in particular equipping it with a back-end module. Specifically, the content delivery apparatus may provide a physical machine having a hypervisor with an installer or patch of the back-end module, or it may push a configuration of the operating system to the physical machine. Alternatively, the content delivery apparatus may simply be a file server hosting the program code implementing the I/O redirection method, and a management of an I/O virtualization system downloads the program code and distributes it to the physical machines that it (indirectly) manages.

To summarize, by redirecting, in para-virtualization, hypercalls from a virtual machine associated with I/O operations, the second procedure, such as scanning for malicious program code, need not be executed on the virtual machine, the computational burden on the underlying physical machine alleviated. Extra management cost is averted due to the fact that the second procedure is updated in one place and only executed when necessary. For the virtual machine and its administrator, there is no concern for loss of control and stability for para-virtualization requires the installation of the front-end module in the first place.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. An input/output (I/O) redirection method comprising:
receiving a call from a virtual machine for a first procedure, the first procedure associated with an I/O operation on the virtual machine;
selectively executing the first procedure; and
selectively calling a second procedure based on an external arrangement in order to obtain an execution result, wherein the second procedure is executed outside of the virtual machine;
wherein the second procedure is called when the external arrangement indicates that the second procedure be called, and the first procedure is executed when the external arrangement indicates that the second procedure not be called.

2. The I/O redirection method of claim 1, wherein the first procedure is selectively executed based on the execution result.

3. The I/O redirection method of claim 2, wherein the I/O operation is associated with an I/O object, the second procedure comprises determining whether there is malicious program code in the I/O object, and when the second procedure is called, selectively executing the first procedure comprises:
executing the first procedure if the execution result indicates that there is not malicious program code in the I/O object; and
refraining from executing the first procedure if the execution result indicates that there is malicious program code in the I/O object.

4. The I/O redirection method of claim 3, wherein the I/O object is a file, and the I/O operation and the first procedure are associated with opening or executing the file.

5. The I/O redirection method of claim 1, wherein the first procedure is executed before the second procedure is selectively called.

6. The I/O redirection method of claim 5, wherein the I/O operation is associated with an I/O object, and the second procedure comprises determining whether there is malicious program code in the I/O object.

7. The I/O redirection method of claim 6, wherein the I/O object is a file, and the I/O operation and the first procedure are associated with closing the file.

8. The I/O redirection method of claim 6, wherein the virtual machine is managed by a hypervisor, the I/O object is a buffer shared between the virtual machine and the hypervisor, the I/O operation is performed through the buffer, and the first procedure is associated with notifying the hypervisor to access the buffer.

9. An input/output (I/O) virtualization system for handling an I/O operation on a virtual machine, the I/O virtualization system comprising:
a front-end module disposed in an operating system of the virtual machine and configured to call a first procedure based on the I/O operation; and
a back-end module disposed in a hypervisor, configured to selectively execute the first procedure, and configured to selectively call a second procedure based on an external arrangement in order to obtain an execution result, wherein the virtual machine is managed by the hypervisor and the second procedure is executed outside of the virtual machine;
wherein the back-end module is configured to call the second procedure when the external arrangement indicates that the second procedure be called, and configured to execute the first procedure when the external arrangement indicates that the second procedure not be called.

10. The I/O virtualization system of claim 9, wherein the back-end module selectively executes the first procedure based on the execution result.

11. The I/O virtualization system of claim 10, wherein the I/O operation is associated with an I/O object, the second procedure comprises determining whether there is malicious program code in the I/O object, and when the second procedure is called, the back-end module executes the first procedure if the execution result indicates that there is not malicious program code in the I/O object, and refrains from executing the first procedure if the execution result indicates that there is malicious program code in the I/O object.

12. The I/O virtualization system of claim 9, wherein the back-end module executes the first procedure before selectively calling the second procedure.

13. The I/O virtualization system of claim 12, wherein the I/O operation is associated with an I/O object, and the second procedure comprises determining whether there is malicious program code in the I/O object.

14. The I/O virtualization system of claim 9, wherein the I/O operation and the first procedure are associated with opening, closing, or executing a file, and the front-end module is further configured to export a file system and synchronize the exported file system with another file system visible to the virtual machine, the exported file system configured to provide access to the file.

15. The I/O virtualization system of claim 14, further comprising:
a procedure executing device configured to mount the exported file system and to execute the second procedure to generate the execution result.

16. The I/O virtualization system of claim 9, wherein the I/O operation is performed through a buffer shared between the front-end module and the back-end module, and the first procedure is associated with notifying the back-end module to access the buffer.

17. The I/O virtualization system of claim 9, further comprising:
a procedure executing device configured to execute the second procedure to generate the execution result.

18. The I/O virtualization system of claim 17, wherein the procedure executing device is further configured to assert the external arrangement.

19. The I/O virtualization system of claim 9, wherein the front-end module comprises a driver in the operating system.

20. The I/O virtualization system of claim 9, wherein the I/O operation comprises a system call to the operating system, and the front-end module forms at least part of the program code configured to handle the system call in the operating system.

21. The I/O virtualization system of claim 20, wherein the system call corresponds to the first procedure.

22. An input/output (I/O) virtualization method for handling an I/O operation on a virtual machine, the I/O virtualization method comprising:
calling, at the virtual machine and based on the I/O operation, a first procedure;
selectively executing the first procedure at a hypervisor, wherein the virtual machines is managed by the hypervisor; and
selectively calling, at the hypervisor and based on an external arrangement, a second procedure in order to obtain an execution result, wherein the second procedure is executed outside of the virtual machine;
wherein the second procedure is called when the external arrangement indicates that the second procedure be called, and the first procedure is executed when the external arrangement indicates that the second procedure not be called.

23. The I/O virtualization method of claim 22, wherein the first procedure is selectively executed based on the execution result.

24. The I/O virtualization method of claim 23, wherein the I/O operation is associated with an I/O object, the second procedure comprises determining whether there is malicious program code in the I/O object, and when the second procedure is called, selectively executing the first procedure comprises:
executing the first procedure if the execution result indicates that there is not malicious program code in the I/O object; and
refraining from executing the first procedure if the execution result indicates that there is malicious program code in the I/O object.

25. The I/O virtualization method of claim 22, wherein the first procedure is executed before the second procedure is selectively called.

26. The I/O virtualization method of claim 25, wherein the I/O operation is associated with an I/O object, and the second procedure comprises determining whether there is malicious program code in the I/O object.

27. The I/O virtualization method of claim 22, wherein the I/O operation and the first procedure are associated with opening, closing, or executing a file, and I/O virtualization method further comprises:
exporting a file system, the file system configured to provide access to the file; and
synchronizing the exported file system with another file system visible to the virtual machine.

28. The I/O virtualization method of claim 22, wherein the I/O operation is performed through a buffer shared between the virtual machine and the hypervisor, and the first procedure is associated with notifying the hypervisor to access the buffer.

29. A content delivery apparatus configured to deploy a computer, causing the computer to be provided with program code which causes the computer to execute a plurality of instructions, the instructions comprising:
receiving a call from a virtual machine for a first procedure, the first procedure associated with an input/output (I/O) operation on the virtual machine;
selectively executing the first procedure; and
selectively calling a second procedure based on an external arrangement in order to obtain an execution result, wherein the second procedure is executed outside of the virtual machine;
wherein the second procedure is called when the external arrangement indicates that the second procedure be called, and the first procedure is executed when the external arrangement indicates that the second procedure not be called.

30. The content delivery apparatus of claim 29, wherein the first procedure is selectively executed based on the execution result.

31. The content delivery apparatus of claim 30, wherein the I/O operation is associated with an I/O object, the second procedure comprises determining whether there is malicious program code in the I/O object, and when the second procedure is called, selectively executing the first procedure comprises:
executing the first procedure if the execution result indicates that there is not malicious program code in the I/O object; and
refraining from executing the first procedure if the execution result indicates that there is malicious program code in the I/O object.

32. The content delivery apparatus of claim 31, wherein the I/O object is a file, and the I/O operation and the first procedure are associated with opening or executing the file.

33. The content delivery apparatus of claim 29, wherein the first procedure is executed before the second procedure is selectively called.

34. The content delivery apparatus of claim 33, wherein the I/O operation is associated with an I/O object, and the second procedure comprises determining whether there is malicious program code in the I/O object.

35. The content delivery apparatus of claim 34, wherein the I/O object is a file, and the I/O operation and the first procedure are associated with closing the file.

36. The content delivery apparatus of claim 34, wherein the virtual machine is managed by a hypervisor, the I/O object is a buffer shared between the virtual machine and the hypervisor, the I/O operation is performed through the buffer, and the first procedure is associated with notifying the hypervisor to access the buffer.
